(19) United States
(12) Patent Application Publication
(10) Pub. No.: US 2026/0244429 A1
(43) Pub. Date: Aug. 20, 2026

(54) DYNAMIC AND REACTIVE METHOD OF LOG PRUNING ON A RUNNING SYSTEM

(71) Applicant: INTERNATIONAL BUSINESS MACHINES CORPORATION, ARMONK, NY (US)

(72) Inventors: STEPHANIE CARYS SHUM, WAPPINGERS FALLS, NY (US); PATRICK JOHN CLAS, PINE PLAINS, NY (US); DAVID JUN, NANUET, NY (US); DAVID MICHAEL WALTERS, MANAHAWKIN, NJ (US)

(21) Appl. No.: 19/058,699

(22) Filed: Feb. 20, 2025

(51) Int. Cl. G06F 8/65

(52) U.S. Cl. CPC G06F 8/65

(57) ABSTRACT

Adjusting settings for pruning system logs includes: analyzing a defect database, determining, based on the analyzing, an update to one or more parameters of system log pruning settings, where the system log pruning settings determine how a system prunes a system log when the system log has exceeded a threshold size, and sending, to the system, the update to the one or more parameters.

### BACKGROUND

### Field of the Disclosure

The field of the disclosure is data processing, or, more specifically, methods, systems, and products for adjusting settings for pruning system error logs.

### Description of Related Art

System error logs are files that contain detailed records of error conditions a computing system encounters and may include records from many components or applications running on the system. Such centralized error logs have a maximum size before they are archived or pruned. However, sometimes pruning the error log can result in losing important data, such as data to be used for further analysis when debugging problems. In conventional systems, error logs are pruned based on manual subject matter expert (SME) inputs to determine the minimum number of logs of a certain type to keep, and which logs are deemed more important than others. Log pruning is typically statically defined in tables and does not consider the current error state of the computing system.

### SUMMARY

Methods, apparatus, and systems for adjusting settings for pruning system error logs according to various embodiments are disclosed in this specification. In accordance with one aspect of the present disclosure, a method of adjusting settings for pruning system error logs includes analyzing a defect database, determining, based on the analyzing, an update to one or more parameters of system log pruning settings, where the system log pruning settings determine how a system prunes a system error log when the system error log has exceeded a threshold size, and sending, to the system, the update to the one or more parameters.

In accordance with another aspect of the present disclosure, a system for adjusting settings for pruning system error logs may include a defect database having multiple defect entries, where each defect entry references one or more error identifiers and includes one or more comments associated with the one or more error identifiers, and a prune settings module configured to: analyze the defect database, determine, based on the analyzing, an update to one or more parameters of system log pruning settings, where the system log pruning settings determine how a system prunes a system error log when the system error log has exceeded a threshold size, and send, to the system, the update to the one or more parameters.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 is a block diagram of an example system configured for adjusting settings for pruning system error logs in accordance with embodiments of the present disclosure.

FIG. 2 is a block diagram of an example computing environment configured for adjusting settings for pruning system error logs according to some embodiments of the present disclosure.

FIG. 3 is a flowchart of an example method for adjusting settings for pruning system error logs according to some embodiments of the present disclosure.

FIG. 4 is a flowchart of another example method for adjusting settings for pruning system error logs according to some embodiments of the present disclosure.

FIG. 5 is a flowchart of another example method for adjusting settings for pruning system error logs according to some embodiments of the present disclosure.

### DETAILED DESCRIPTION

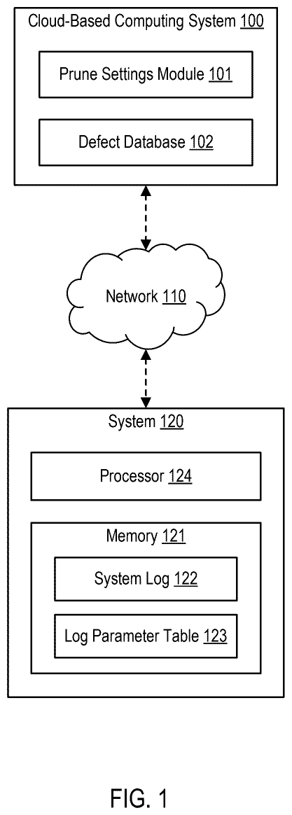

Exemplary methods, systems, and products for adjusting settings for pruning system error logs in accordance with the present disclosure are described with reference to the accompanying drawings, beginning with FIG. 1. FIG. 1 sets forth a block diagram of an example system configured for adjusting settings for pruning system error logs in accordance with embodiments of the present disclosure. The example of FIG. 1 includes cloud-based computing system 100, which includes prune settings module 101 and defect database 102. The example of FIG. 1 also includes system 120, which is coupled to cloud-based computing system 100 via a network (such as network 110). The example system 120 of FIG. 1 includes a processor 124 and memory 121, where the memory 121 includes a system log 122 and a log parameter table 123.

The example system log 122 of FIG. 1 is a file that contains detailed records of error conditions that system 120 may encounter. The system log 122 includes error logs from many components or subcomponents running on the system. The system log may also contain event logs, informational logs, security logs, and the like, some of which may be associated with or related to an experienced error. In the remaining disclosure, reference to any logs within the system that are associated with or related to an experienced error will be referred to as ‘system error logs’. As such, these system error logs may be error logs included within the system log 122, or may be some other type of log, such as an informational log, included within the system log 122 that is associated with an experienced error or other defect. A component is a system application, program, firmware, software component, or may also include physical hardware components of the system. A subcomponent is a part of a component, where multiple subcomponents may make up a component. When a given component or subcomponent experiences an error, the system 120 is configured to store a log entry within the system log 122, where the log entry includes an error identifier (e.g., ABCD1234) identifying the associated component or subcomponent, and an error type. In some embodiments, a log entry in the system log may also include a description of the error. In one example, a system may add a log entry to the system log 122 in response to a security portion of firmware experiencing an error, where the log entry identifies the component (firmware), the subcomponent (security), and the error type, or a description of the specific error experienced.

System logs are typically pruned (reduced in size) once they reach a certain file size. The example system 120 of FIG. 1 is configured to prune system log 122 once the system log reaches a threshold file size. Pruning the system log includes removing or deleting multiple log entries from the log. In some embodiments, pruning the error log includes removing a given number of log entries until the error log has reached a specified file size (e.g., 85% of the max file size allowed). In some embodiments, components (and their associated log entries) are pruned individually within the system log, and according to one or more rules. The rules defining how the system 120 will prune the system log 122 are defined in log parameter table 123. That is, log parameter table 123 includes ‘system log pruning settings’ that define a set of parameters for each component (and subcomponent) that is configured to store error log entries within the system log 122. Each set of parameters defines a priority setting and a log entry minimum for a given component (or subcomponent). Accordingly, the log parameter table is divided into multiple entries, where each log parameter table entry identifies a component, a subcomponent (if applicable), a priority setting, and a log entry minimum.

In the example log parameter table 123 of FIG. 1, a priority setting identifies a priority level (or number) assigned to a given component or subcomponent. For example, critical system programs or applications may be assigned a higher priority level than less important memory management programs, or the like. When pruning the system log, system 120 may prune the error log based on the priority setting assigned to each component. In one example embodiment, the system may prune the system log by first deleting only log entries from components or subcomponents with the lowest priority setting. In such an example, if the system log still requires further pruning (such as to reach a threshold pruning size), the system may then proceed to delete log entries from components or subcomponents with the second lowest priority setting, and so on until the system log has been sufficiently pruned.

In the example log parameter table 123 of FIG. 1, a log entry minimum is assigned to each component or subcomponent and identifies the amount of log entries that are to be left over after the given component (or subcomponent) has had it's log entries deleted or pruned during the pruning of the system log. That is, the log entry minimum for a given component assures that a specified number of log entries (for that component) are left over within the system log after the system log has been pruned. Such a setting is important to make sure that not all of the error log entries for a given component are deleted when pruning the system log, which may allow for future debugging or system servicing. By allowing each component to have its own specified log entry minimum, the system is configured to allow some components to have a higher number of leftover log entries after pruning than others.

Sometimes, components that abuse logging (log excessive amounts of error log entries in the system log) can cause important error log entries to be deleted during pruning more frequently. Conventionally, the settings defining how a system prunes the system error log are adjusted manually based on subject matter expert (SME) input in defects, which can result in costly error reproduction requests. In such conventional systems, log pruning is statically defined in tables and does not consider the current error state of the system. The present disclosure defines systems and methods configured to use defect analysis to automatically adjust log pruning settings, such as component minimums and priorities, and also recommend if certain components could benefit from being further divided into additional subcomponents or by using their own error log (rather than using the shared system log).

The example defect database 102 of FIG. 1 includes defect entries that each reference one or more error identifiers (or components) and includes one or more comments (e.g. from engineers, system admins, or SME's) related to the defect. The defect entries in the defect database describe defect events (i.e. issues caused when pruning the system log) and include commentary from users or admins describing the defect events and how the error log pruning affected or caused the defect. For example, a comment included within a defect entry in the defect database may say “the frequent occurrence of [error identifier A] has caused the important [error identifier B] to get improperly pruned.” Such an example comment addresses a situation where an important error log entry (which may have been needed to identify or diagnose a system issue) was accidentally deleted from the system log while it was pruned, where the pruning was a result of excessive error logging from another component. In some embodiments, the defect entries each include a title, one or more references to error identifiers, and one or more comments. In the example of FIG. 1, the defect database is included in the cloud (such as in the cloud-based computing system 100). The cloud-based computing system 100 is coupled to system 120 via network 110 and also includes prune settings module 101. In other embodiments (not shown in FIG. 1), the prune settings module is included in a separate cloud computing system, or in a system (such as system 120).

The example prune settings module 101 of FIG. 1 is configured to perform the various described embodiments of the present disclosure. In some embodiments, the prune settings module 101 is configured to analyze the defect database 102 and then determine (based on the analyzing) how to update parameters of the system log pruning settings and then send the determined update to the system (to update the log parameter table 123 according to the update). In such embodiments, the prune settings module 101 is configured to dynamically adjust the system log pruning settings to optimize how system 120 prunes its system log 122 based on an analysis of issues arising from pruning. Adjusting the system log pruning settings includes updating the log parameter table 123 in system 120. In one embodiment, the prune settings module 101 is configured to send an instruction to system 120 indicating how to modify or update the log parameter table according to the determined update. In such an embodiment, the instruction sent to system includes one or more updated component priority settings or log entry minimums. In another embodiment, the prune settings module 101 is configured to send an updated log parameter table to the system to replace the existing table. In some embodiments, the prune settings module 101 has a copy of the current log parameter table 123 that is on the system 120, in order to know which updates are required for the system. In one embodiment, the prune settings module 101 is configured to receive a copy of the log parameter table from system 120 (and subsequently determine how to update the table based on the analysis of the defect database).

In one embodiment, the prune settings module 101 of FIG. 1 is configured to determine a reference frequency for each error identifier referenced within the defect database 102 (i.e. how many times, or how often, a given error identifier is referenced or discussed within the defect database). Such a determination allows the prune settings module 101 to determine which error identifiers (or associated components) cause issues/defects and how often they are causing such defects. Upon making such a determination, the prune settings module 101 is configured to subsequently determine an update to the pruning settings which will prevent the identified defects from being pruned out of the log, thereby aiding in future debugging. For example, responsive to determining that a given error identifier is regularly being improperly deleted from the system log during pruning (leading to notable recurring defects documented in the defect database), prune settings module 101 is configured to adjust the pruning settings accordingly (such as by increasing a log entry minimum for the component associated with the given error identifier). Such an adjustment to the pruning settings will result in less error log entries being removed during pruning for that given error identifier/associated component, which in turn reduces the likelihood of these errors getting improperly pruned in the case that the error occurs again.

In another embodiment, the prune settings module 101 of FIG. 1 is configured to also consider components or subcomponents that could be causing defects but that are not showing up (either at all or frequently) within the defect database. That is, the prune settings module 101 is configured to analyze the system log, determine an error identifier that is referenced within the system log more than a first threshold amount of times, and throttle a component associated with the error identifier. In some embodiments, the determined error identifier has a reference frequency below a second threshold (i.e. is referenced within the defect database less frequently than a second threshold amount). Such an embodiment is useful because an error identifier or an associated component may still be causing defects even if they are not being frequently referenced in the defect database. In such an embodiment, the prune settings module 101 is configured to isolate components or their error identifiers that are causing defects independent of the rate at which they are being referenced in the defect database. Upon identifying such components, the prune settings module 101 is configured to throttle the error logging of those components (thereby reducing the amount of error log entries (or other related informational log entries) being added to the system log).

In another embodiment, the prune settings module 101 of FIG. 1 is configured to, as part of analyzing the defect database, perform natural language processing (NLP) on comments and other data included within the defect database 102 to determine more information about the error identifiers being referenced there. For example, for a given error identifier, the prune settings module 101 is configured to analyze the defect database by parsing the defect database for defect entries or comments that contain the given error identifier. Once a defect entry or comment is found, the prune settings module 101 is configured to perform sentiment analysis to determine whether the comment is describing the given error identifier in a positive or negative manner. Such an embodiment may be carried out as a method of weighting the error identifier (or associated component) to actively manage the priority setting corresponding to that error identifier or component. In some examples, a more positive sentiment will increase priority while a negative sentiment will decrease priority.

For example, important error identifiers are error identifiers that are frequently mentioned in comments that may be missing in the system log 122 due to log pruning. For example, a comment stating “There should be an error identifier ABCD1234 in the error log showing a request was submitted; however, due to log pruning, the data is possibly missing” would be an example of a comment describing the importance of error identifier ABCD1234 in the context of a pruning situation. Such an example comment would be used by prune settings module 101 to update a priority setting associated with the error identifier. Further, a different comment calling out an error identifier for log abuse (i.e. “The constant logging of error identifier AAAA1234 is causing significant log pruning, unfortunately we cannot determine the root cause of the issue without additional data”) could be used to do the opposite analysis to decrease the priority setting for error identifier AAAA1234 (and its associated component or subcomponent).

In another embodiment, the prune settings module 101 of FIG. 1 is configured to send to the system 120, based on analyzing the defect database, a recommendation to include error log entries for a specified component within a component-specific error log instead of within the system log. That is, upon determining that there are more than a threshold amount of error log entries for a given component that are causing issues for other components, and that throttling that given component is not a viable option, the prune settings module 101 may determine that the given component should store its error log entries in its own separate independent error log instead of taking up significant valuable space within the system log.

In another embodiment, the prune settings module 101 of FIG. 1 is configured to send to the system 120, based on the analyzing the defect database, a recommendation to divide a specified component into one or more subcomponents, where each of the one or more subcomponents is given an associated set of parameters in the log parameter table 123. That is, upon determining that a given component is too broad, where all the different parts of the component have their error log entries getting pruned together, but where certain important parts of the component are regularly having its log entries pruned prematurely, the prune settings module 101 may determine that the component should be divided into one or more subcomponents in order to protect those important parts of the components from being improperly pruned. Such an embodiment also may help alleviate defects while still sufficiently pruning the other parts of the component, thereby optimizing efficiency by avoiding defects while also allowing for sufficient pruning.

In one embodiment, the first time that the defect database is analyzed according to the above described method, the prune settings module 101 is configured to analyze the entire defect database as a whole, and subsequently make any and all updates to the pruning settings deemed necessary. However, in subsequent embodiments, where the defect database has already been fully analyzed for the first time, the defect database will continue to add more defect entries, and so the prune settings module 101 is configured to continue analyzing only the new entries being added to the defect database going forward. That is, each time a new issue or defect is added to the defect database 102, the prune settings module 101 will be triggered to analyze that newly added issue or defect entry to determine if the prune settings should be further adjusted. Upon determining that the prune settings should indeed be further adjusted, the prune settings module 101 will determine how to update the settings and then send another update to the system.

In some embodiments, the prune settings module 101 is configured to reverse an update to the prune settings based on a determination that the update led to additional useless data in the logs instead of helping to add relevant debug information.

In some embodiments, each time the prune settings module 101 analyzes the defect database and determines an update to the prune settings, the prune settings module 101 is configured to store that update (or information related to the update) in memory. Such an embodiment allows for future reference to how the prune settings were successively updated over time and may aid in determining the reasoning behind each of those updates, as well as the results of each of those updates. In some embodiments, the update (and information describing the analysis behind the update) is stored in memory local to the prune settings module 101, memory local to the defect database, within the defect database, or some other separate location. In some embodiments, such data is stored in system 120.

In another embodiment, the system 120 is configured to preemptively prune, redirect, or throttle errors in order to prevent one or more components from abusing the system log and thus prolong the log before pruning is required. That is, the system 120 is configured to determining when an excessive amount (i.e. an amount above a threshold) of error log entries are being stored by a given component even before, or independent of whether, the system log has reached its maximum file size and thus requires pruning.

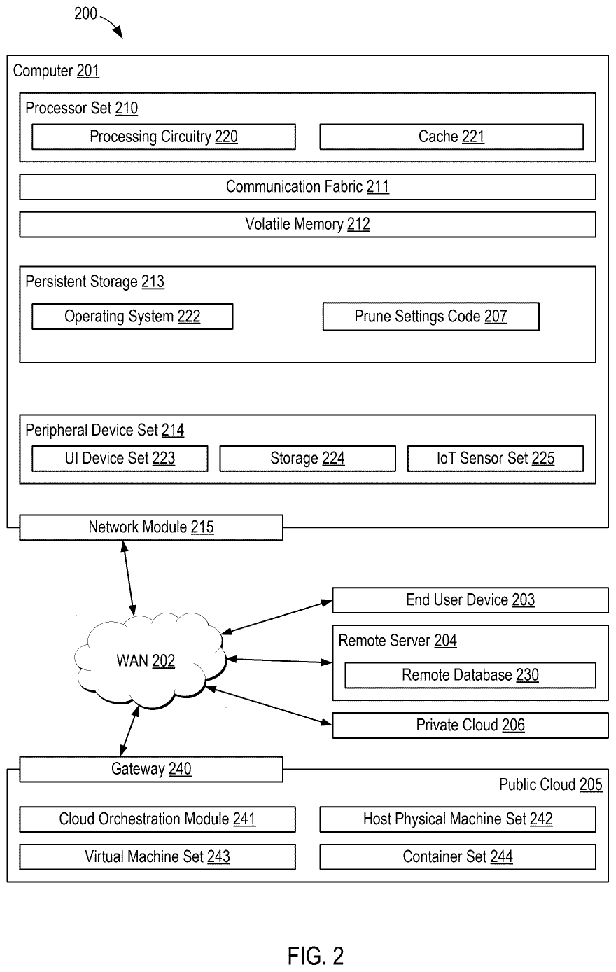

For further explanation, FIG. 2 sets forth a block diagram of computing environment 200 configured for dynamically reducing FFDC resource consumption in accordance with embodiments of the present disclosure. Computing environment 200 contains an example of an environment for the execution of at least some of the computer code involved in performing the inventive methods, such as prune settings code 207 or operating system 222. In addition to prune settings code 207, computing environment 200 includes, for example, computer 201, wide area network (WAN) 202, end user device (EUD) 203, remote server 204, public cloud 205, and private cloud 206. In this example embodiment, computer 201 may include the cloud-based computing system 100 shown in FIG. 1, and includes processor set 210 (including processing circuitry 220 and cache 221), communication fabric 211, volatile memory 212, persistent storage 213 (including operating system 222 and prune settings code 207, as identified above), peripheral device set 214 (including user interface (UI) device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244. In one embodiment, the prune settings code 207 is included in the prune settings module 101 and is configured to analyze the defect database, determine an update to parameters, and send the update to the system. In another embodiment, the prune settings code 207 is included within the operating system 222.

Computer 201 may take the form of a desktop computer, laptop computer, tablet computer, smart phone, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in prune settings code 207 in persistent storage 213.

Communication fabric 211 is the signal conduction path that allows the various components of computer 201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface-type operating systems that employ a kernel. The code included in prune settings code 207 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215. Network module 215 may be configured to communicate with other systems or devices, such as sensors 225, for receiving sensor measurements.

WAN 202 is any wide area network (for example, the internet) capable of communicating computer data over non-local distances by any technology for communicating computer data, now known or to be developed in the future. In some embodiments, the WAN 202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

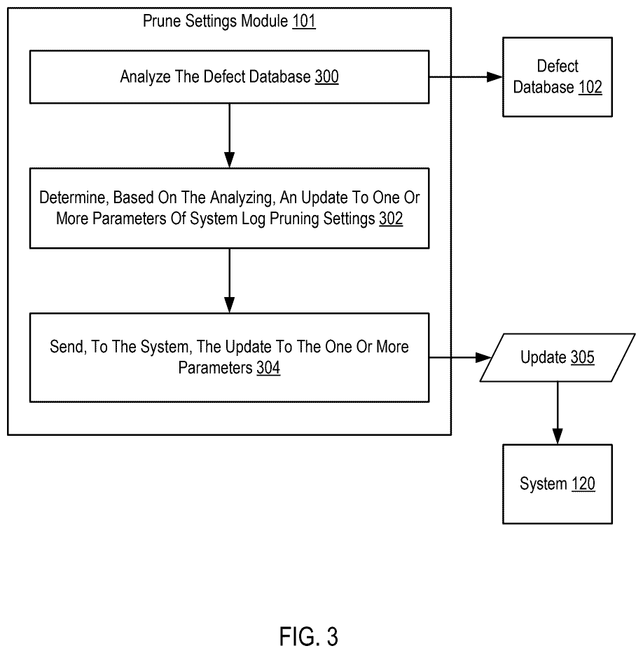

For further explanation, FIG. 3 sets forth a flow chart illustrating an exemplary method of adjusting settings for pruning system error logs according to embodiments of the present disclosure. The method of FIG. 3 includes analyzing 300 the defect database. Analyzing 300 the defect database may be carried out by prune settings module 101 parsing through the defect database for defect entries or comments that contain an error identifier from the system log in order to gather data about the defect database. In some embodiments, analyzing the defect database includes storing data or information determined through the analysis of the defect data, where such data may be stored local to the prune settings module.

The method of FIG. 3 also includes determining 302, based on the analyzing of the defect database, an update to one or more parameters of system log pruning settings. Determining 302 an update to one or more parameters of system log pruning settings may be carried out by prune settings module 101 by determining an adjustment to a priority setting or a log entry minimum for one or more components (or subcomponents). For example, determining an update may include weighting an error identifier (or associated component) to actively manage, adjust, or update the priority setting corresponding to that error identifier or component. In another example, responsive to determining (in the analysis of the defect database) that a given error identifier is regularly being improperly deleted from the system log during pruning (leading to notable recurring defects documented in the defect database), prune settings module 101 is configured to determine an adjustment to the pruning settings (i.e. by increasing a log entry minimum for the component associated with the given error identifier). Such an update to the pruning settings will result in less error log entries being removed during pruning for that given error identifier/associated component, which in turn reduces the likelihood that this error will get improperly pruned in the future, and increases the value of the debug data, thereby allowing for development to fix the problem and release a patch which in turn will reduce the likelihood of this error occurring again. In some embodiments, determining the update may include referencing the log parameter table 123 on the system 120, which may include requesting the table from the system or referencing a copy of the table (that is kept up to date) local to the prune settings module or otherwise in the cloud environment accessible to the prune settings module.

The method of FIG. 3 also includes sending 304, to the system, the update to the one or more parameters. Sending 304, to the system, the update to the one or more parameters may be carried out by prune settings module 101 sending the update 305 to system 120 over a network. In one embodiment, sending the update 305 to the system includes sending an instruction to system 120 indicating how to modify or update the log parameter table according to the determined update. In such an embodiment, the instruction sent to system includes one or more updated component priority settings or log entry minimums. In another embodiment, the prune settings module 101 is configured to send an updated log parameter table to the system to replace the existing table. In some embodiments, the prune settings module 101 has a copy of the current log parameter table 123 that is on the system 120, in order to know which updates are required for the system. In one embodiment, the prune settings module 101 is configured to receive a copy of the log parameter table from system 120 (and subsequently determine how to update the table based on the analysis of the defect database).

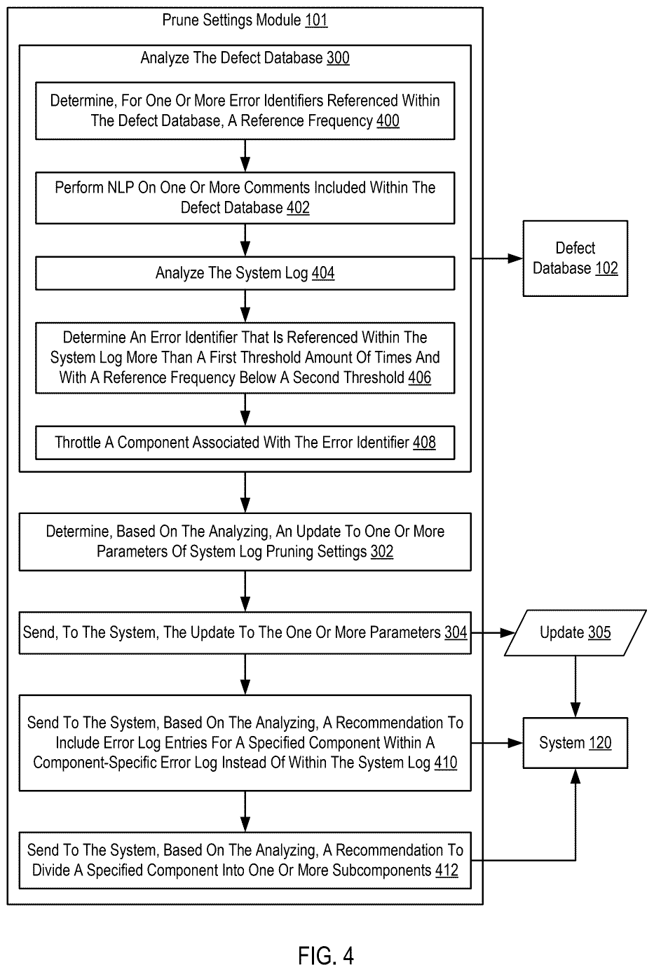

For further explanation, FIG. 4 sets forth a flow chart illustrating another exemplary method of adjusting settings for pruning system error logs according to embodiments of the present disclosure. The method of FIG. 4 differs from the method of FIG. 3 in that the method of FIG. 4 further includes, as part of analyzing 300 the defect database, determining 400, for one or more error identifiers referenced within the defect database, a reference frequency. Determining 400, for one or more error identifiers referenced within the defect database, a reference frequency may be carried out by prune settings module 101 by determining how many times, or how often, a given error identifier is referenced or discussed within the defect database. Such a determination may be made for every error identifier or component referenced within the defect database. Such a determination allows the prune settings module 101 to determine which error identifiers (or associated components) cause issues/defects and how often they are causing such defects.

The method of FIG. 4 also includes, as part of analyzing 300 the defect database, performing 402, NLP on one or more comments included within the defect database. Performing 402, NLP on one or more comments included within the defect database may be carried out by prune settings module 101 by performing sentiment analysis for each error identifier or component referenced within the defect database to determine whether the comment is describing a given error identifier in a positive or negative manner. Such an embodiment may be carried out as a method of weighting the error identifier (or associated component) to actively manage the priority setting corresponding to that error identifier or component. In some examples, a more positive sentiment will increase priority while a negative sentiment will decrease priority. In other embodiments, such an embodiment may be carried out as a method of determining whether a given error identifier should have a corresponding log entry minimum adjusted (such as when NLP results in a determination that a comment indicates a given error identifier is too commonly deleted during pruning).

The method of FIG. 4 also includes, as part of analyzing 300 the defect database, analyzing 404 the system log, determining 406 an error identifier that is referenced within the system log more than a first threshold amount of times and with a reference frequency below a second threshold, and throttling 408 a component associated with the error identifier. Analyzing 404 the system log, determining 406 an error identifier, and throttling 408 a component associated with the error identifier may be carried out by prune settings module 101 to consider components or subcomponents that could be causing defects but that are not showing up (either at all or frequently) within the defect database. In some embodiments, the determined error identifier has a reference frequency below a second threshold (i.e. is referenced within the defect database less frequently than a second threshold amount). Such an embodiment allows the prune settings module to identify an error identifier or an associated component that may still be causing defects even if they are not being frequently referenced in the defect database. In such an embodiment, the prune settings module 101 is configured to isolate components or their error identifiers that are causing defects independent of whether they are being frequently referenced in the defect database. Upon identifying such components, the prune settings module 101 is configured to throttle the error logging of those components (thereby reducing the amount of error log entries being added to the system log).

The method of FIG. 4 also includes sending 410 to the system, based on the analyzing, a recommendation to include error log entries for a specified component within a component-specific error log instead of within the system log. Sending 410 to the system a recommendation to include error log entries for a specified component within a component-specific error log instead of within the system log may be carried out by prune settings module 101 based on a determination that the above analysis of the defect database satisfies multiple conditions. Specifically, the prune settings module may determine that there are more than a threshold amount of error log entries for a given component that are causing issues for other components, and that throttling that given component is not a viable option. Upon such determinations, the prune settings module 101 may determine that the given component should store its error log entries in its own separate independent error log instead of taking up significant valuable space within the system log.

The method of FIG. 4 also includes sending 412 to the system, based on the analyzing, a recommendation to divide a specified component into one or more subcomponents. Sending 410 to the system a recommendation to divide a specified component into one or more subcomponents may be carried out by prune settings module 101 based on a determination that a given component is too broad, where all the different parts of the component have their error log entries getting pruned together, but where certain important parts of the component are regularly having its log entries pruned prematurely. In such an embodiment, the prune settings module 101 may determine that the component should be divided into one or more subcomponents in order to protect those important parts of the components from being improperly pruned. Such an embodiment also may help alleviate defects while still sufficiently pruning the other parts of the component, thereby optimizing efficiency by avoiding defects while also allowing for sufficient pruning. In such an embodiment, each of the one or more subcomponents is given an associated set of parameters in the log parameter table 123.

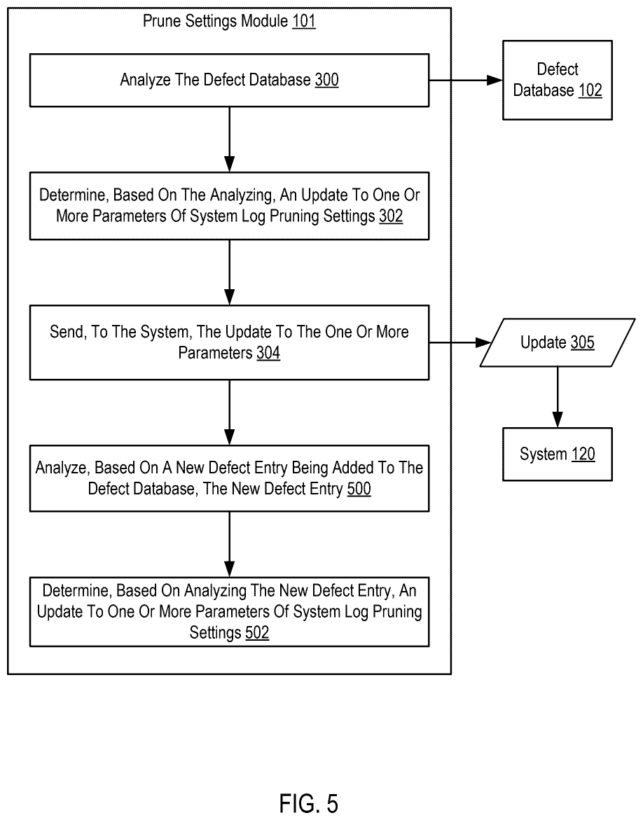

For further explanation, FIG. 5 sets forth a flow chart illustrating another exemplary method of adjusting settings for pruning system error logs according to embodiments of the present disclosure. The method of FIG. 5 considers an embodiment where the defect database has already been fully analyzed for a first time and any newly added defect entry to the defect database are subsequently analyzed, as they are added, for potential subsequent prune settings updates. Specifically, the method of FIG. 5 differs from the method of FIG. 3 in that the method of FIG. 5 further includes analyzing 500, based on a new defect entry being added to the defect database, the new defect entry. Analyzing 500 the new defect entry may be carried out by prune settings module 101 responsive to a new defect entry being added to the defect database. In some embodiments, the analyzing 500 is performed responsive to determining additional data or comments have been added to an existing defect entry in the defect database. That is, each time a new issue or defect (or comment) is added to the defect database 102, the prune settings module 101 will be triggered to analyze that newly added issue or defect entry to determine if the prune settings should be further adjusted. Upon determining that the prune settings should indeed be further adjusted, the prune settings module 101 is configured to determine 502, based on analyzing the new defect entry, an update to one or more parameters of system log pruning settings. That is, the prune settings module 101 is configured to determine how to update the settings and then send the additional update to the system.

In view of the explanations set forth above, readers will recognize that the benefits of adjusting settings for pruning system error logs according to embodiments of the present disclosure include:
Increasing system performance by optimizing the pruning of system logs to avoid unnecessarily causing debugging issues from improper error log pruning.
Increasing system health by preventing excessive or unnecessary system defects, such as by allowing for debugging problems without having to reproduce them because the system log includes all the debug data required (since it is no longer being improperly pruned).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method of adjusting settings for pruning system error logs, the method comprising:
analyzing a defect database;
determining, based on the analyzing, an update to one or more parameters of system log pruning settings, wherein the system log pruning settings determine how a system prunes a system log when the system log has exceeded a threshold size; and
sending, to the system, the update to the one or more parameters.

2. The method of claim 1, wherein the system log pruning settings define a set of parameters for each of a plurality of components associated with the system log, wherein the set of parameters for each of the plurality of components includes a priority setting and a log entry minimum.

3. The method of claim 1, wherein analyzing the defect database includes determining, for one or more error identifiers referenced within the defect database, a reference frequency.

4. The method of claim 3, further comprising:
analyzing the system log;
determining an error identifier that is referenced within the system log more than a first threshold amount of times and with a reference frequency below a second threshold; and
throttling a component associated with the error identifier.

5. The method of claim 1, wherein analyzing the defect database includes performing natural language processing (NLP) on one or more comments included within the defect database.

6. The method of claim 1, further comprising sending to the system, based on the analyzing, a recommendation to include error log entries for a specified component within a component-specific error log instead of within the system log.

7. The method of claim 1, further comprising sending to the system, based on the analyzing, a recommendation to divide a specified component into one or more subcomponents, wherein each of the one or more subcomponents has an associated set of parameters of the system log pruning settings.

8. The method of claim 1, wherein the defect database is located within a cloud computing environment.

9. The method of claim 8, wherein each of the analyzing, the determining, and the sending, is carried out by an application hosted on the cloud computing environment.

10. A system for adjusting settings for pruning system error logs, the system comprising:
a defect database comprising a plurality of defect entries, wherein each defect entry references one or more error identifiers and includes one or more comments associated with the one or more error identifiers; and
a prune settings module configured to:
analyze the defect database;
determine, based on the analyzing, an update to one or more parameters of system log pruning settings, wherein the system log pruning settings determine how a system prunes a system log when the system log has exceeded a threshold size; and
send, to the system, the update to the one or more parameters.

11. The system of claim 10, wherein the system log pruning settings define a set of parameters for each of a plurality of components associated with the system log, wherein the set of parameters for each of the plurality of components includes a priority setting and a log entry minimum.

12. The system of claim 10, wherein analyzing the defect database includes determining, for one or more error identifiers referenced within the defect database, a reference frequency.

13. The system of claim 12, wherein the prune settings module is further configured to:
analyze the system log;
determine an error identifier that is referenced within the system log more than a first threshold amount of times and with a reference frequency below a second threshold; and
throttle a component associated with the error identifier.

14. The system of claim 10, wherein analyzing the defect database includes performing natural language processing (NLP) on one or more comments included within the defect database.

15. The system of claim 10, further comprising sending to the system, based on the analyzing, a recommendation to include error log entries for a specified component within a component-specific error log instead of within the system log.

16. The system of claim 10, further comprising sending to the system, based on the analyzing, a recommendation to divide a specified component into one or more subcomponents, wherein each of the one or more subcomponents has an associated set of parameters of the system log pruning settings.

17. The system of claim 10, wherein the system is included within a cloud computing environment.

18. A computer program product comprising a computer readable storage medium and computer program instructions stored therein that, when executed, are configured to:
analyze a defect database;
determine, based on the analyzing, an update to one or more parameters of system log pruning settings, wherein the system log pruning settings determine how a system prunes a system log when the system log has exceeded a threshold size; and
send, to the system, the update to the one or more parameters.

19. The computer program product of claim 18, wherein the system log pruning settings define a set of parameters for each of a plurality of components associated with the system log, wherein the set of parameters for each of the plurality of components includes a priority setting and a log entry minimum.

20. The computer program product of claim 18, wherein analyzing the defect database includes determining, for one or more error identifiers referenced within the defect database, a reference frequency.
